(19) United States
(12) Patent Application Publication
(10) Pub. No.: US 2017/0105426 A1
(43) Pub. Date: Apr. 20, 2017

(54) A METHOD FOR PRODUCING A DAIRY PRODUCT AND SUCH DAIRY PRODUCT

(71) Applicant: Tnuva Central Cooperative for the Marketing of Agricultural Produce in Israel Ltd., Ramat Hasharon (IL)

(72) Inventors: Hod Yanover, Modiin (IL); Bettina Glatstein Sarel, Shtulim (IL)

(21) Appl. No.: 15/128,313

(22) PCT Filed: Mar. 24, 2015
(86) PCT No.: PCT/IL2015/050308

§ 371 Date: Sep. 22, 2016

(30) Foreign Application Priority Data
Mar. 26, 2014 (IL) 231713

(51) Int. Cl. A23G 1/56; A23L 9/10; A23G 1/46

(52) U.S. Cl. CPC A23G 1/56; A23G 1/46; A23L 9/10; A23V 2002/00

(57) ABSTRACT

The present disclosure provides a method for producing a chocolate rich product and a chocolate rich product obtained thereby, where the chocolate rich product is characterized by at least one of (i) at least 5% chocolate, (ii) stability during storage at a temperature range of between 4° C. and 10° C. for a period of at least 21 days; and (iii) dry matter in the range of 20-45% and (iv) a texture profile characterized by at least one of: (a) gel strength of above between 140 g to 300 g; (b) adhesiveness indicator of between 60 g to 140 g.

### TECHNOLOGICAL FIELD

The present invention relates to the food industry, including the dairy industry, and in particular to chocolate based products.

### BACKGROUND ART

The references considered to be relevant as background to the presently disclosed subject matter are listed below:
JP 4920075;
US 2011/0274813;
U.S. Pat. No. 4,910,035.

Acknowledgement of the above references herein is not to be inferred as meaning that these are in any way relevant to the patentability of the presently disclosed subject matter.

### BACKGROUND

Chocolate based food products have been prepared for many years. Such chocolate products include chocolate confectionaries, chocolate pudding, mouse or gels, chocolate bars, and the like.

When preparing milk containing chocolate, efforts are made to provide those that are, on the one hand rich in chocolate, and on the other hand, microbially stable. For example, Japanese Patent No. 4920075 describes an industrial method for producing cacao pudding that contains chocolate with good bacterial stability, and pudding produced by the method. Specifically, the method disclosed by JP4920075 includes a cacao liquid preparing step of preparing a cacao liquid by mixing a. liquid containing a first emulsifier of HLB of 9-16 with a cacao component comprising chocolate and cocoa and having the content of the chocolate of 50-99 cocoa mass percent, a cacao emulsified liquid preparing step of preparing a cacao emulsified liquid by mixing the cacao liquid with a second emulsifier of HLB of 4-7, a raw material liquid preparing step of preparing a raw material liquid by mixing the cacao emulsified liquid with a gelling agent-containing component, and a sterilizotion step of sterilizing the raw material liquid.

US 2011/0274813 describes semi-solid or liquid chocolate compositions produced by mixing a rice starch gel into a chocolate base mass.

U.S. Pat. No. 4,910,035 describes a process for producing flavored drinks, specifically chocolate milk by mixing lambda carrageenan, flavorings and milk

### GENERAL DESCRIPTION

The present disclosure provides, in accordance with its broadest aspect, a method for producing a chocolate rich product comprising:

(a) in a first container, preparing a chocolate melt by mixing solid chocolate into milk, the amount of chocolate being at least 20% (w/w) out of the total weight of the chocolate melt, said milk being at a temperature above 40° C.;

(b) in a second container, preparing a stabilizing composition by mixing at least one edible stabilizer with milk being at a temperature between about 4° C. and 55° C., said milk having a fat content that corresponds with a desired fat content of the chocolate rich product to obtain a stabilizing composition;

(c) mixing the chocolate melt with the stabilizing composition at a mixing ratio of between about 20% to 50% chocolate rich melt to about 80%-50% stabilizing composition to obtain a chocolate rich base;

(d) subjecting the chocolate rich base to a homogenization process to obtain a homogenized chocolate rich base;

(e) subjecting the homogenized chocolate rich base to a pasteurization process to obtain a pasteurized chocolate rich base; and

(f) cooling the pasteurized chocolate rich base to a final temperature of between 10° C. to 30° C. to obtain the chocolate rich product;

wherein the chocolate rich product is characterized by
at least 5% w/w chocolate;
a texture profile characterized by at least one of gel strength of between 140 g to 300 g and adhesiveness indicator of between 60 g to 140 g (absolute value);
stability during storage at a temperature range of between 4° C. and 10° C. for a period of at least 30 days; and
dry matter in the range of 20-45% w/w.

Also provided by the present disclosure, in accordance with a second of its aspects, is a chocolate rich product comprising a homogenous mixture of milk, at least one edible stabilizer, and at least 5% chocolate comprising cocoa butter, the product being characterized by a texture profile comprising gel strength between 140 g and 300 g, an adhesiveness indicator of between 60 g and 140 g; and stability during storage for a period of at least 21 days.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1D are images of a chocolate rich product according to an embodiment of the present disclosure (FIG. 1A) and of comparative products (FIGS. 1B-1D), after storage at 4° C.

### DETAILED DESCRIPTION OF EMBODIMENTS

The present disclosure provides a method for producing a chocolate rich product, as well as a chocolate rich product, as defined herein.

In the broadest scope, the method of producing the chocolate rich product comprises:
(a) preparing, in a first container, a chocolate melt by mixing solid chocolate comprising cocoa butter into milk, the amount of chocolate being at least 20% (w/w) out of the total weight of the chocolate melt, said milk being at a temperature above 40° C.;
(b) preparing, in a second container, a stabilizing composition by mixing at least one edible stabilizer with milk being at a temperature between about 4° C. and 55° C., said milk having a fat content that corresponds with a desired fat content of the chocolate rich product to obtain a stabilizing composition; then
(c) mixing the chocolate melt with the stabilizing composition at a mixing ratio of between about 20% to 50% of the chocolate rich melt to about 80%-50% of the stabilizing composition, to obtain an homogenous chocolate rich base;
(d) subjecting the chocolate rich base to a homogenization process to obtain a homogenized chocolate rich base; (e)subjecting the homogenized chocolate rich base to a pasteurization process to obtain a pasteurized chocolate rich base; and
(f) cooling the pasteurized chocolate rich base to a final temperature of between 10° C. to 30° C. to obtain the chocolate rich product.

The chocolate rich product disclosed herein or provided by the present method, is a priori characterized by the following parameters:
(i) it comprises at least 5%, at times, at least 6%, or at least 7% or even at least 8% chocolate, and in some examples, at times up to 25%, or between 5% to 25% or between 8% to 25%;
(ii) it has a texture profile defined by at least one of gel strength of between 140 g to 300 g, at times 150 g to 190 g, and adhesiveness indicator having an absolute value between 60 g to 140 g, at times 70 g to 130 g;
(iii) it is stable during storage at a temperature range of between 4° C. and 10° C. for a period of at least 21 days, at times, at least 25 days, or at least 30 days;
(iv) it comprises dry matter in the range of 20-40%, at times 20%-45%, at times 35-40%.

According to some embodiments, the chocolate product is also characterized by a microbial count of less than 10 CFU/g.

According to some other embodiments, the chocolate product disclosed herein is also characterized by a homogenous texture (i.e. no visual phase separation).

According to yet some further embodiments, the chocolate product disclosed herein is also characterized by color stability, namely no visible change from a color parameter predetermined for the particular product (depending, inter alia, on the percentage of chocolate/type of chocolate used in preparation, the percentage of fat etc.).

Yet further, in accordance with some embodiments, the chocolate product disclosed herein is also characterized by pH of between 6.4 to 7.2, at times, 6.7 to 6.9, and further at times, 6.75-6.88.

Yet further, in accordance with some embodiments, the chocolate product disclosed herein is also characterized by organoleptic parameters, i.e. with no change compared to a predetermined threshold.

Yet further, in accordance with some embodiments, the chocolate rich product not comprising preservatives disclosed herein is characterized by its long term stability during storage (long shelf life in terms of chemical stability, physical stability and microbial stability) at a temperature range of between 4° C. and 10° C. for a period of at least 21 days, preferably for a period of at least 25 or even for a period of at least 30 days.

The chocolate rich product of the present invention comprises chocolate per se, i.e., chocolate solids comprising cocoa butter (i.e., the fat naturally present in cocoa beans, being in solid state at room temperature). In this context, it is to be understood that the cocoa butter encompasses, inter alia, dark chocolate and/or white chocolate.

In the context of the present disclosure, the term “chocolate solids” (also referred herein “cocoa solids”) refers to solids derived from cocoa beans that contain at least cocoa butter. Cocoa solids refer to any cocoa constituent, including cocoa butter, cocoa mass (i.e., cocoa powder, or in other words, what is left after removing cocoa butter from cocoa liquor), cocoa liquor, or any blend of these.

Chocolate in the form of dark chocolate includes a combination of cocoa mass and cocoa butter. When the dark chocolate additionally contains milk powder or condensed milk, the chocolate is recognized as milk chocolate. Further, white chocolate contains cocoa butter, sugar, and optionally milk but no cocoa mass.

Thus, in the context of the present invention when referring to chocolate it should be understood to encompass chocolate of any or combination of the above forms (dark, milk, white).

As appreciated, the amount of cocoa mass in the chocolate may vary from 50% to 99% cocoa mass (in accordance with the Israeli standards of chocolate).

In some other embodiments, the chocolate to be used is selected from the group consisting of dark chocolate, milk chocolate and white chocolate. In one embodiment, the chocolate to be used is dark chocolate, namely, chocolate comprising at least cocoa mass and cocoa butter.

In some other embodiments, the chocolate is milk chocolate.

In some embodiments, the chocolate is white chocolate.

The chocolate rich product in accordance with the present disclosure is thus an edible product, including milk based product but also products that include a milk substituent (as further discussed below), that comprises at least about 5% w/w chocolate.

In some embodiments, the chocolate rich product is one comprising between 5% to 25% chocolate, at times, between 15-20%, and further at times, between 5% to 20% chocolate, and at further times, at least 6%, 7%, 8%, 9%, 10%, 11%, 12%, 13%, 14% or 15%. In some embodiments, the chocolate rich product is one comprising between 6% to 25% chocolate, 6% to 22% chocolate, 6% to 20% chocolate, 6% to 16% chocolate or 6% to 15% chocolate. In some embodiments, the chocolate rich product is one comprising between 7% to 25% chocolate, 7% to 22% chocolate, 7% to 20% chocolate, 7% to 16% chocolate or 7% to 15% chocolate. In some embodiments, the chocolate rich product is one comprising between 8% to 25% chocolate, 8% to 22% chocolate, 8% to 20% chocolate, 8% to 16% chocolate or 8% to 15% chocolate. In some other embodiments, the chocolate rich product is one comprising between 10% to 25% chocolate, 10% to 22% chocolate, 10% to 20% chocolate or 10% to 15% chocolate.

In yet some other embodiments, the chocolate rich product is one comprising between 12% to 25% chocolate, 12% to 20% chocolate, 12% to 18% chocolate or 12% to 16% chocolate.

In yet some other embodiments, the chocolate rich product is one comprising any one of: at most 25%, at most 24%, at most 23%, at most 22%, at most 21%, at most 20% chocolate.

Reverting to the method disclosed herein, solid chocolate is mixed into milk When referring to “milk” it is to be understood as having its commonly used meaning, namely, a white dairy liquid produced by mammals (e.g. cow, goat, sheep), including its powdered form or its lactose free form, as well as milk derived from a plant source, such as, and without being limited thereto, soy, rice, almond, hazelnut and coconut milk

Further, when referring to milk it is to be understood as encompassing not only whole milk but also low-fat milk, skim milk (e.g. up to 0.2% fat), fresh milk and milk cream (i.e. the fat portion of the milk)

In some embodiments, the milk is fresh milk, i e , that was not subjected to any processing, including pasteurization and/or homogenization.

At times, the milk is recombined milk based on milk powder. Recombined milk results from the combining of milk-fat and milk-solids-non-fat in their preserved forms with the addition of water to achieve the appropriate milk product composition including the protein and fat, as present in raw milk.

In some other embodiments, the milk is skim milk, i.e., milk from which at least part of its fat has been removed to bring the percentage of milk fat in the milk to less than 3% or 2%, at times, less or equal to 1%, or even less or equal to 0.2%.

In yet some other embodiments, the milk comprises a combination of skim milk with cream.

In some embodiments, solid chocolate is mixed into a container comprising at least milk, at times, milk with cream. In this connection, it is to be noted that cocoa mass are to be distinguished from solid chocolate, the latter referring to chocolate per se, including cocoa mass and fat, and being in solid state.

In some embodiments, the milk is a priori heated to a temperature at which the chocolate melts, this being at least 40° C. In yet some other embodiments, the temperature is above 40°, e.g. between 40° C. to 80° C., at times, between 40° C. to 65° C., between 45° C. to 65° C. or any other temperature within the range of between 40° C. to 80° C.

The mixing of the solid chocolate with the milk, at the above recited temperatures, results in the melting of the solid chocolate within the milk, to obtain an essentially homogenous fluid, referred to as a chocolate melt.

In some embodiments, the fat content of the solid chocolate being mixed with the milk is in the range of 20% to 40%, at times, 25% to 35%, at times 29% to 33% or any other range within 20% to 30%.

The amount of solid chocolate mixed with the milk is selected such to constitute at least 20% (w/w) out of the total weight of the chocolate melt. In some embodiments, the amount of chocolate is at least 25% (w/w), between 20% to 50% (w/w), at times, 25% to 40% (w/w) out of the total weight of the chocolate melt. At times, an acidity regulator may be added as further discussed below.

The milk to be used for melting the solid chocolate is selected to be compatible, in terms of fat content, with the chocolate used. In some embodiments, the milk is one having a milk fat content that corresponds with the fat content of the solid chocolate. Without being limited by theory, fat compatibility is required in order to ensure homogenous mixing of the chocolate within the milk

In this context, when referring to “milk fat content” it is to be understood as the content of milk fat in the first container, this including the milk as well as the cream, when the latter is also included.

In some embodiments, the milk fat content is within the range of 0.2% and 35% w/w. The percentage of milk fat used will be determined on the desired fat content in the final product (the chocolate product). Therefore, in accordance with some embodiments, in order to increase the fat content of the final product, the fat content of the chocolate melt is increased. This may be achieved by using either more chocolate (providing the fat from the chocolate fat) or by using a milk with a higher fat content.

The method also comprises preparing a stabilizing composition to be mixed with the chocolate melt, as described.

The stabilizing composition is prepared by mixing at least one food additive with milk being at a temperature between about 4° C. and 55° C.

Food additives may be divided into categories or groups in accordance with the Functional Classes of the Codex Alimentarius (international standards relating to food stuff), such as, acidity regulators, emulsifiers, flavors, gelling agents, preservatives, stabilizers, sweeteners and thickeners.

In addition, food additives are typically E-coded within the European Union according to their category. The coding of the food additives signifies the safety assessment and approval by the European Food Safety Authority. For example, all thickeners, stabilizers and emulsifiers are E-coded E400-E499.

In some embodiments, the at least one food additive is an edible stabilizer.

The term “edible stabilizer” is to be understood by its meaning acceptable in the food industry, namely, an edible additive added to food stuff to stabilize one or more parameters of the food. When referring to stabilization it is to be understood as including at least the preservation of the texture of the food stuff (for a desired period of time), but also other physical characteristic.

In addition to the edible stabilizer, the stabilizing composition may also comprise additional food additives commonly used in the food industry.

In some embodiments, the additional food additive comprises one or more saccharides, this including monosaccharides, disaccharides, oligosaccharides and polysaccharides.

In some embodiments, the saccharide is a sugar, namely, a mono or disaccharide, including, without being limited thereto, sucrose, fructose, galactose, glucose, maltose and lactose. In this context, when referring to “sugar”, it is to be understood as including also any other chemically-related sweet-flavored substances used in food industry, including artificial sweeteners.

In some embodiments, the sugar is sucrose.

In some embodiments, the additional food additive comprises polysaccharides, this including starch as well as carrageenan, guar gum, LBG (i.e., Locust Bean Gum), xanthan gum, pectin, tara gum. In one embodiment, the polysaccharide is starch. In some embodiments, the starch is one having the E-codes of E1442 and E1424.

In some embodiments, the additional food additive comprises cocoa powder. The term “cocoa powder” is to be understood as acceptable in the art, namely, a mixture of substances remaining after cocoa butter is extracted from cacao beans. In some embodiments, the stabilizing composition comprises cocoa powder of 10-12% fat.

In some embodiments, the additional food additive comprises vanillin. The term “vanillin” is to be understood as acceptable in the food industry, namely, the primary component extract of vanilla bean, or a synthetic vanillin used as a flavoring agent.

In some embodiments, the additional food additive is an “emulsifier” namely, an edible substance capable of emulsifying the composition. Without being limited thereto, the emulsifier is one selected from the group consisting mono and diglycerides of fatty acids and their esters with organic acids. The may be from a natural source, from either plant or animal origin, or synthetic.

In some embodiments, the emulsifier is comprised of a mono or di-glyceride of fatty acids or a mixture thereof, known by the commercial abbreviation E471 or E472b.

In some embodiments, the food additive is an “acidity regulator” to be added to allow maintaining the composition in a desired pH. The acidity regulator may be any regulator suitable in the food industry in accordance with the Functional Classes of the Codex Alimentarius, such as organic or mineral acids, bases, neutralizing agents or buffering agents. Without being limited thereto, the acidity regulator is selected from the group consisting of sodium phosphate, sodium phosphate, monosodium phosphate, disodium phosphate, trisodium phosphate, tetrasodium pyrophosphate or mixtures thereof, known by their commercial abbreviation, E450iii and E339. In some embodiments, the acidity regulator is tetrasodium pyrophosphate.

In some further embodiments, the additional food additive is a flavoring agent, which is known in the art.

The stabilizing composition may include any combination of the above food additives.

The stabilizing composition is prepared by mixing milk with at least one stabilizer, optionally with one or more food additive. The milk may be a combination of milk with cream, as noted above. The total milk fat content in the milk to be used in preparing the stabilizing composition is selected to correspond with the fat content desired for the final chocolate rich product. For instance, if the method aims at providing a chocolate rich product with 10% fat, and the chocolate melt contains 15% fat (cocoa fat and milk fat) the milk used for preparing the stabilizing composition, which may be 70% of the final product weight, will be one having a total milk fat content of about 8%.

The mixing of the milk, stabilizer and optionally other food additives, as defined herein, is at a temperature allowing essentially homogenous mixing of the components. In some embodiments, the mixing is at a temperature within a range of 4° C-55° C.

Notably, the determination of temperature of mixing in the second container is correlated, inter alia, with the duration of mixing, with the aim of minimizing risks or preventing the development of microbial spores. Thus, when the temperature is high, the mixing duration will be set to be short, and similarly, when the temperature is low, the duration of mixing may be set to be longer, and vice versa.

Accordingly, in some embodiments, the temperature range in the second container is between 20° C. to 55° C., and the mixing is for a time period of no more than 2 hours.

In some embodiments, the temperature range in the second container is between 40° C. to 55° C., and the mixing is for a time period of no more than one hour.

In some other embodiments, the mixing in the second container is at a temperature range of between 5° C. to 10° C. This low temperature allows mixing to take place for several hours, even for three hours.

Once the chocolate melt and the stabilizing compositions are prepared, they are mixed together. The mixing of the chocolate melt and the stabilizing compositions provides a chocolate rich base.

In the context of the present disclosure, the “chocolate rich base” is to be understood as the fluid mixing of at least chocolate, milk, and stabilizing composition (stabilizers including any aforementioned additional food additives).

According to the present disclosure, the mixing of the chocolate melt into the stabilizing composition is possible for a chocolate melt composition based on milk having liphophilic properties, and this, in turn, allows the necessary fat compatibility.

The mixing of the chocolate melt and the stabilizing composition is under conditions that provide a chocolate rich base. In some embodiments, the chocolate rich base is a homogenous mixture of the above recited components.

In the context of the present disclosure, when referring to “homogenous mixture” it is to be understood to denote uniformity in distribution in one or more of the composition's substances, texture, color and phase. Therefore, a continuous mixing, at times even agitation is required in order to eliminate phase separation and particle sedimentation.

The chocolate rich base is then subjected to a homogenization process to obtain a homogenized chocolate rich base. At times, the chocolate rich base is heated prior to homogenization.

The homogenization process is conducted with the chocolate rich base that was heated to a temperature between 40° C. and 70° C., at times, between 50° C. and 55° C. and then subjecting the heated chocolate base to the homogenization process.

In some embodiments, the homogenization process is a one stage homogenization process. When a single/one stage homogenization process is employed, the chocolate rich base may be subjected to pressure, according to some embodiments, to a pressure in the range of 50 to 200 bar.

In some other embodiments, the homogenization process is a two stage homogenization process. In some embodiments, the two stage homogenization is performed under a pressure in the range of 50 to 200 bar.

The homogenized chocolate rich base is then subjected to a pasteurization process to obtain a pasteurized chocolate rich base. The pasteurization step is performed in order to receive F₀ value of 3.3 by subjecting the chocolate rich base to heat for defined time duration. The F₀ value dictates the relationship between pasteurization duration and temperature of pasteurization required to ensure killing of bacteria to a level below a predetermined threshold.

At times, the homogenized chocolate rich base is heated to a temperature between 100° C. to 200° C. for a time period of 1 to 60 seconds. At times, the homogenized chocolate rich base is heated to a temperature between 120° C. to 150° C. for 2 to 32 seconds, as shown in Table 1. At times, the homogenized chocolate rich base is heated to a temperature between 135° C. to 141° C. for 2 to 8 seconds.

TABLE 1
Time and temperature required for pasteurization

| | Pasteurization | Pasteurization |
|---|---|---|
| No. | Temperature [° C.] | Time [seconds] |
| 1 | 141 | 2 |
| 2 | 138 | 4 |
| 3 | 135 | 8 |
| 4 | 132 | 16 |
| 5 | 129 | 32 |

In the non-limiting examples presented herein, the homogenized chocolate rich base is pasteurized at a temperature of 138° C. for 4 seconds.

The pasteurized chocolate rich base is then cooled. In some embodiments, the cooling is performed stepwise, including stepwise subjecting the chocolate base to at least two temperatures or temperature ranges. In accordance with one embodiment, the pasteurized chocolate rich base is firstly subjected to a temperature or temperature gradient within the range of 50° C. to 70° C. In some embodiments, the cooling of the pasteurized chocolate rich base to a temperature within the above temperature range is while being transferred with a conduit from the pasteurizer toward its storage container.

A second temperature or temperature gradient to which the chocolate rich base is subjected to is within the range of 10° C. to 30° C. In some embodiments, the chocolate rich base is subjected to the second temperature (or temperature gradient) while being transferred through a second cooler and transferred/pumped from the cooler into the storage container, namely, proximal to the storage container's inlet.

In the context of the present disclosure, the storage container is typically under aseptic conditions suitable for long term storage. The storage container may be an industrial storage unit, as well as the commercial cup in which the product is sold.

As noted above, the present disclosure also provides the chocolate rich product, per se or as provided by the disclosed method.

The chocolate rich product may be characterized by one or more parameters obtained by texture profile analysis (TPA). Without being limited thereto, the texture profile analysis is to be understood as encompassing commonly acceptable mechanical testing of food that show the relationship between these mechanical tests and the texture of the food. Specifically and without being limited thereto, TPA measures such parameters as hardness, springiness, chewiness, gumminess, cohesiveness, gel strength, adhesiveness, brittleness (fracture force), firmness, ripeness, fracture force, yield point, elasticity, spreadability, tackiness, consistency, burst strength, relaxation, breaking point, pliability, gel strength and apparent modulus. The TPA may be conducted using any commonly used systems, such as, without being limited thereto, a Stable Micro System TAX2.

In some embodiments, the chocolate rich product is characterized by a gel-strength of between 140 g to 300 g, at times between 150 g to 190 g, at times between 160 g to 190 g, at times between 140 g to 160 g, and further at times, between 145 g to 155 g, and at times, about 150 g.

In some further embodiments, the chocolate rich product is characterized by adhesiveness indicator within the range of 60 g to 140 g, at times, 60 g to 90 g, at times between 70 g and 90 g, and further at times between 65 g to 75 g or about 70 g. When referring to adhesiveness indicator and to the values provided herein, it is to be understood that they refer to absolute values of, e.g. 60 g and the adhesiveness value may be equally expressed as a negative (−60 g) or positive (+60 g) value, depending on the direction of movement of the measurement device.

The chocolate rich product may also be characterized by its long term stability during storage (long shelf life) at a temperature range of between 4° C. and 10° C. for a period of at least 21, 24, 25, 26, 27, 28, 29 or 30 days, at times, for a period of 33, 36, 39, 42 and even more than 45 days.

In the context of the present disclosure, when referring to stability it is to be understood as meaning one or more of chemical stability, physical stability and microbial stability.

When referring to “chemical stability” it is to be understood as referring to stability or lack of detectable change in terms of taste, color, pH, odor and the like, as compared to an acceptable standard for the product. For instance, a detectable change in pH of 0.5, 0.2 or even 0.1, as compared to a predetermined pH value for a chemically stable product, would be indicative of chemical instability of chemical deterioration of the product.

When referring to “physical stability” it is to be understood as referring to stability or lack of detectable change in terms of texture, viscosity, firmness, phase separation as compared to an acceptable standard value for the product. For example, gel strength may be determined using TAX2 penetration test, or by using oscillatory test for flowing behavior/rheological parameters and a change in any of these parameters as compared to a predetermined threshold for each parameter may be indicative of physical instability or deterioration.

When referring to “microbial stability” it is to be understood as referring to lack of detectable colony forming units in the product or maintenance (lack of increase) in the number of colony forming units in the product.

In some embodiments, the chocolate rich product is characterized by its dry matter content. In this context, it is to be understood that “dry matter” refers to the amount of mass of the chocolate rich product when measured in completely dry form. One may use a weight % ratio between the liquid and total dry matter. In some embodiments, the liquid to total dry matter in the chocolate rich product may be between 20% to 45%, at times, between 30% to 40%, and further at times, between 35% to 40%. The dry matter in a product may be measured by any known method in the field, for example by infra-red or microwave heating and after fully drying the material to obtain the dry solid content.

In some embodiments, the chocolate rich product is characterized by a pH of between 6.4 to 7.2.

The chocolate rich product is characterized by a rich chocolate mouth-feel, evaluated by the palate of an individual through mastication, swallowing and aftertaste. Rich chocolate mouth-feel attributes can be perceived as long lasting textural sensation, high body, high mouth coating, creamy smoothness and pleasant stickiness.

### SOME NON-LIMITING EXAMPLES

In the following non-limiting examples, the solid chocolate used for preparation of the chocolate melt is milk chocolate of 29-33% cocoa mass.

### Example 1

### Preparation of Chocolate Rich (15% Cocoa Mass) Dairy Product

Chocolate rich product was generally prepared by preparing two separate “components” in two respective containers, which were then mixed under special conditions, a chocolate melt and a stabilizing composition. The ingredients used for the two components are specified in Table 2:

TABLE 2
Ingredients for chocolate product #1

| | | | | % w/w |
|---|---|---|---|---|
| | | Type and source | | final |
| Component | Ingredient | of ingredient | % w/w | product |
| Chocolate | Milk | 3.5% fat | 49.8% | 14.9% |
| Melt | Solid | milk chocolate | 50% | 15% |
| | chocolate | (29-33% cocoa | | |
| | | mass, | | |
| | | Uniliver) | | |
| | Cream | 42% fat | 0% | 0% |
| | Acidity | tetrasodium | 0.2% | 0.06% |
| | regulator | pyrophosphate | | |
| | | (E450iii) | | |
| Stabilizing | Milk | 5.5% fat | 85% | 59.45% |
| Composition | Sugar | Sugat | 8.3% | 5.8% |
| | Starch | waxy maize | 3.1% | 2.2% |
| | | (E1442) | | |
| | Cocoa | D-11-S 10-12% | 2.7% | 1.9% |
| | powder | fat, ADM | | |
| | Carrageenan | E407, Tate & | 0.4% | 0.3% |
| | | Lyle | | |
| | Emulsifier | E471, Tate & | 0.4% | 0.3% |
| | | Lyle | | |
| | Vanillin | Frutarom | 0.18% | 0.013% |
| | Acidity | tetrasodium | 0.1% | 0.07% |
| | regulator | pyrophosphate | | |
| | | (E450iii) | | |

### Preparing a Chocolate Melt:

A chocolate melt was prepared by mixing, in a first container, the solid chocolate, with fresh milk, at a temperature of 60° C. until the solid chocolate completely melted. Then, the pH of the milk was adjusted to 6.5-7 by adding the pH regulator, namely, E450iii to the chocolate melt container, (this is required to prevent denaturation of milk proteins). Then, in a slow process, the solid chocolate was added to the hot milk, which was agitated until the solid chocolate was completely melted. In this stage, effective agitation was required to avoid sedimentation of solid particles. Subsequently, the hot chocolate melt was pumped through a cooler and cooled down to a temperature of 20° C. to obtain a “cooled rich chocolate melt”.

Preparing a Stabilizing Composition:

In another container, the stabilizing composition was prepared by mixing under air suction conditions fresh milk being at a temperature of 4-8° C. with the food additives detailed in Table 2 above. Continuous agitation was required to avoid sedimentation of powder particles until an essentially homogenous mixture was formed.

Preparing a Chocolate Rich Base

Subsequently, the cooled rich chocolate melt was pumped into the second container, into the stabilizing composition at a ratio of 30% rich chocolate melt to 70% stabilizing composition.

The chocolate rich base was subjected to a HTST (“High-Temperature Short-Time”) pasteurization treatment, including the following steps:

a) heating the chocolate rich base to 50° C-55° C.;

b) homogenizing by a GEA 2 stages piston homogenizer at a pressure of 150/50 bar at the temperature of 50-55° C.;

c) heating the homogenized chocolate rich base to a temperature of 138° C. for approximately 4 seconds.

d) cooling the pasteurized chocolate rich base to 60° C.

e) pumping the chocolate rich base toward the storage container

f) cooling down the chocolate rich base through wide plate heat exchanger to 20° C., just before the storage container inlet.

The pasteurized chocolate rich base was stored (up to 48 hours) in the storage container until sending to filling machine and then into the final cups and sealed therein.

The filling of the pasteurized chocolate rich base to the cups was under ultraclean conditions. The final product (the pasteurized chocolate rich base sealed in the cups) was stored at 4° C. and as further shown below, was stable for at least 30 days.

The final chocolate rich product was obtained by filling and sealing the product in a container/cup and then kept in a refrigerator at a temperature of about 4° C.

### Product Analysis:

### Texture Profile Test

A prototype of the chocolate rich product #1 was filled in cups under ultra clean conditions—control atmosphere chamber, positive filtered (HEPA) air flow, sterile cups etc. The following results were provided after 30 days of shelf life:
Microbial test—coliform, yeast and molds—less then 10 CFU/g;
Phase separation test—homogeneous appearance with no phase separation;
Color stability test—no change in color;
pH stability test—no change in pH (pH=6.75-6.88);
Organoleptic evaluation—no change in comparison to fresh product.

### COMPARATIVE EXAMPLE

In order to assess the significance of the steps and conditions of the manufacturing process, the following comparative examples were conducted. Specifically, comparison was made with the ingredients and/or steps and/or conditions set out in JP4920075.

### Example 2

### Preparation of Comparative Product #2

A comparative product (#2) was prepared in accordance with the procedure described in JP4920075 with the ingredients of JP4920075 (see test #6, recipe #32 in JP4920075), which are further specified in Table 3.

TABLE 3
Ingredients for chocolate comparative product #2

| | | | Amount | HLB |
|---|---|---|---|---|
| Component | Materials | Features | (%) | range |
| Chocolate | 1^{st} Emulsifier | E472c - 39% | 1 | 10-12 |
| Melt | | Sucrose - 61% | | |
| | 2^{nd} Emulsifier | E471 - 100% | 0.4 | 3-7 |
| | Solid chocolate | 29% cacao mass | 8 | — |
| | Cacao powder | 10-12% fat | 2 | — |
| | Water | — | 38.6 | — |
| | Subtotal | — | 50 | — |
| Other | Agar | — | 0.2 | — |
| ingredients | Skim milk | 0-1.25% fat | 8 | — |
| solution | powder | | | |
| | Sugar | (by Sugat) | 9.4 | — |
| | Water | — | 32.4 | — |
| | Subtotal | — | 50 | — |
| | Total | — | 100 | — |

Using the above ingredients, chocolate product #2 was prepared by first dispersing the 1^{st} Emulsifier (E472c and sucrose) in water (as in JP4920075) at a temperature of 70° C. Then milk chocolate and cocoa powder were added and the emulsion was stirred for 3 minutes to form a chocolate melt.

Subsequently, the 2^{nd} Emulsifier (E471), was added to the solution and stirred until full dissolution (for about 3 minutes) to obtain an emulsified chocolate melt.

The other ingredients detailed in Table 3 were separately dissolved in water and then added to the emulsified chocolate melt which was then heated to 75° C., followed by a pasteurization process at 138° C. for 4 seconds using the same equipment as described in Example 1, with a first cooling to 85° C., homogenization at 80 bar and subsequent cooling to 60° C.

### Example 3

### Preparation of Comparative Product #3

A comparative product (#3) was prepared in accordance with the procedure of JP4920075. In product #3 the recipe includes ingredients according to the present invention with addition of 1^{st} and 2^{nd} emulsifiers used in product #2 (as in JP4920075), as specified in Table 4:

TABLE 4
Ingredients for comparative product #3

| | | | Amount | HLB |
|---|---|---|---|---|
| Component | Materials | Features | (%) | range |
| Chocolate | 1^{st} Emulsifier | E472c - 39% | 1 | 10-12 |
| Melt | | Sucrose - 61% | | |
| | 2^{nd} Emulsifier | E471 - 100% | 0.4 | 3-7 |
| | Solid chocolate | 29-33% cacao | 15 | — |
| | | mass, | | |
| | | (Uniliver) | | |
| | Cacao powder | 10-12% fat | 1.9 | — |
| | Acidity regulator | E450iii | 0.2 | — |
| | Skim milk | 0-0.2% fat | 28.5 | — |
| | Cream | 42% fat | 3 | — |
| | Subtotal | — | 50 | — |
| Other | Stabilizers | E407 - 42% | 0.6 | — |
| ingredients | mixture | E471 - 10% | | |
| solution | (PUD40) | Sucrose - 48% | | |
| | Skim milk powder | 0-1.25% fat | 2.8 | — |
| | Sugar | (Sugat) | 6.6 | — |
| | Modified starch | E1442 | 2.2 | — |
| | (Thermflo) | | | |
| | Acidity regulator | E450iii | 0.07 | |
| | Skim milk | 0-0.2% fat | 35.1 | |
| | Cream | 42% fat | 2.6 | |
| | Subtotal | — | 50 | — |
| | Total | — | 100 | — |

Using the above ingredients, comparative product #3 was prepared by first dispersing the 1^{st} Emulsifier (E472c and sucrose) in skim milk and cream at a temperature of 70° C., followed by the addition of the acidity regulator. Then chocolate with a content of 29-33% cocoa mass and the cocoa powder were added to the emulsion under stirring, for 3 minutes to form a chocolate melt.

Subsequently, a 2^{nd} Emulsifier II (E471) was added to the chocolate melt and stirred until full dissolution (for about 3 minutes) to obtain an emulsified chocolate melt.

The other ingredients detailed in Table 4 were separately dissolved in milk and cream, and then added to the emulsified chocolate melt which was then heated to 75° C., followed by a pasteurization process at 138° C. for 4 seconds using the same equipment as described in Example 1, with a first cooling to 85° C., homogenization at 80 bar and subsequent cooling to 60° C.

### Example 4

### Preparation of Comparative Product #4

A comparative product (#4) was prepared in accordance with the method disclosed herein, making use of the emulsifiers described in JP4920075, with the ingredients specified in Table 5:

TABLE 5
Ingredients for comparative product #4

| | | Detailed | Dosage | HLB |
|---|---|---|---|---|
| Component | Materials | description | (%) | range |
| Chocolate | 1^{st} Emulsifier | E472c - 39% | 1 | 10-12 |
| Melt | | Sucrose - 61% | | |
| | 2^{nd} Emulsifier | E471 - 100% | 0.4 | 3-7 |
| | Solid chocolate | 29-33% cacao | 15 | — |
| | | mass, | | |
| | | (Uniliver) | | |
| | Cacao powder | 10-12% fat | 1.9 | — |
| | Acidity regulator | E450ii | 0.2 | — |
| | Skim milk | 0-0.2% fat | 28.5 | — |
| | Cream | 42% fat | 3 | — |
| | Subtotal | — | 50 | — |
| Other | Stabilizers | E407 - 42% | 0.6 | — |
| ingredients | mixture | E471 - 10% | | |
| solution | | Sucrose - 48% | | |
| | Skim milk powder | 0-1.25% fat | 2.8 | — |
| | Sugar | — | 6.6 | — |
| | Modified starch | E1442 | 2.2 | — |
| | Acidity regulator | — | 0.07 | |
| | Skim milk | 0-0.2% | 35.1 | |
| | Cream 42% fat | — | 2.6 | |
| | Subtotal | — | 50 | — |
| | Total | — | 100 | — |

Using the above ingredients, comparative product #4 was prepared by initially dispensing the 1^{st} Emulsifier (E472c and sucrose) with skim milk and cream at a temperature of 70° C., followed by the addition of the acidity regulator. Then solid chocolate and cocoa powder were added and the resulting emulsion was stirred for 3 minutes to form a chocolate melt.

Subsequently, the 2^{nd} Emulsifier (E471) was added to the solution and stirred until full dissolution (for about 3 minutes) to obtain an emulsified chocolate melt.

The other ingredients detailed in Table 5 were separately dissolved in milk and cream as mentioned in Table 5, and then added to the emulsified chocolate melt which was then heated to 55° C., followed by a homogenization process at 50/150 bar, followed by pasteurization at 138° C. for 4 seconds using the same equipment as described in Example 1, with a subsequent cooling to 20° C.

### Product Analysis:

### Texture Profile Analysis

Texture profile analysis (TPA) was conducted to determine the profile of the chocolate rich product. Specifically, gel strength and adhesiveness of the chocolate rich product disclosed herein and of each comparative product #, were determined TPA was conducted on a Stable Micro System TAX2 equipped with a P25 spindle at a temperature of 4-7° C.

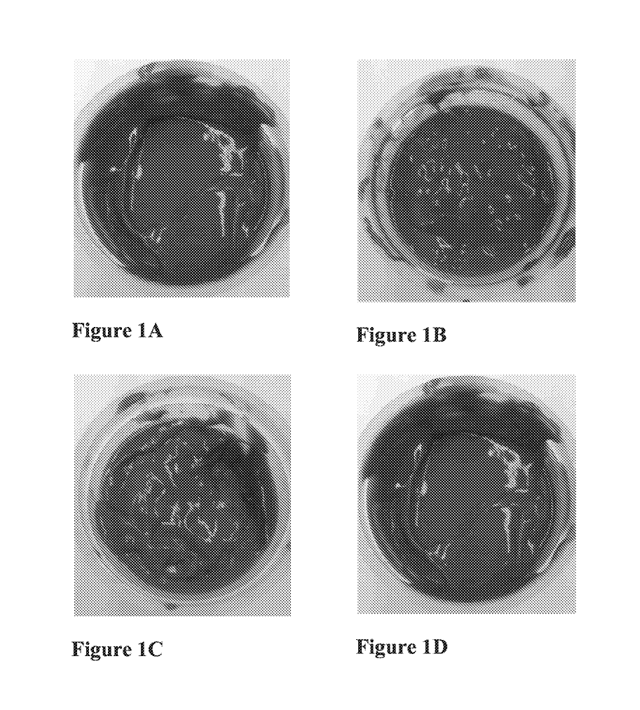

Table 6 provides the TPA and stability tests for each product and FIGS. 1A-1D images of the various products.

TABLE 6
Product characterization

| | Chocolate | | | |
|---|---|---|---|---|
| | rich | Comparative | Comparative | Comparative |
| Parameter | product #1 | Product #2 | Product #3 | Product #4 |
| Dry matter (%) | 38-39 | 28.7 | 38.9 | 39.2 |

TPA

| | | | | |
|---|---|---|---|---|
| Max force, | 0.18 | 0.11 | 0.52 | 0.28 |
| Gel strength, | | | | |
| (kg) | | | | |
| Min force, | 0.09 | 0.03 | 0.16 | 0.13 |
| Adhesiveness, | | | | |
| (kg) | | | | |
| Texture | Creamy, | Weak, | Tendency to | Creamy, |
| | thick, | brittle gel, | gelation, | thick, |
| | spoonable, | light “body”, | thick, | smooth, |
| | rich body, | some | rough/ | spoonable, |
| | no | syneresis | broken | rich body, |
| | syneresis | | surface, | no |
| | | | rich body, | syneresis |
| | | | some | |
| | | | syneresis | |

As evident from the above Table 6 and FIGS. 1A-1D, the chocolate rich product of the present invention displayed the most preferable texture being creamy, thick, spoonable, rich body with no syneresis (water separation). Further, the chocolate rich product of the present invention was characterized with gel strength of 180 g and adhesiveness factor of, in absolute values, 90 g and showed microbial stability.

Comparative product #2 was prepared according to the materials and method of JP4920075 and was found to be less favorable due to its weakness, brittleness, light body with some syneresis (water separation). Comparative product #2 was characterized with low values of gel strength of 110 g and adhesiveness factor, in absolute values, of 30 g.

Comparative product #3 was prepared according to the procedure of JP4920075 but using ingredients in accordance employed in the exemplified chocolate rich product (Example 1) with addition of 1^{st} and 2^{nd} emulsifiers used in product #2 (as in JP4920075). Comparative product #3 displayed a less favorable texture as it was found to be thick and with a tendency to jellify. Comparative product #3 also had a rough/broken surface, rich body and exhibited some syneresis (water separation). Sample 3 was characterized with high values of gel strength of 520 g and adhesiveness factor, in absolute values, of 160 g.

Finally, Comparative product #4 was prepared according to the procedure and ingredients of Example 1, albeit using the emulsifiers of JP4920075. The product #4 displayed a creamy and thick texture which was also smooth, spoonable, rich body with no syneresis (physical separation). Comparative product #4 was also characterized with gel strength of 280 g and adhesiveness factor of, in absolute values 130 g.

### Examples of Chocolate Rich Dairy Product Comprising Skim Milk and Skim Milk Powder:

### Example 5

### Preparation of Chocolate Rich Dairy Product #5 of the Present Invention Comprising 15% Chocolate and Liquid Skim Milk

Chocolate rich product according to the present invention comprising 15% chocolate was prepared as similarly detailed in the preparation of Example 1 (chocolate rich product #1) above, but with liquid skim milk (containing 0.2% fat) instead of milk containing 3.5% fat.

The ingredients used for preparing chocolate rich dairy_product #5 are provided in Table 7 below.

To ensure homogenous mixing of the chocolate within the milk, the milk fat content should correspond with the fat content of the solid chocolate. In the case of using skim milk with low fat content, cream containing 42% fat was added to the chocolate melt component in order to correlate the total milk fat content with the fat content of the solid chocolate in the chocolate melt component.

### Example 6

### Preparation of Chocolate Rich Dairy Product #6 of the Present Invention Comprising 15% Chocolate and Skim Milk Powder

Chocolate rich product according to the present invention comprising 15% chocolate was similarly prepared as Example 5 above, but with skim milk powder (containing max 1.25% fat).

The ingredients used for preparing chocolate rich dairy_product #6 comprising skim milk powder are provided in Table 8 below.

As in the case of Example 5, cream containing 42% fat was added to the chocolate melt component in order to correlate the total milk fat content with the fat content of the solid chocolate in the chocolate melt component.

TABLE 7
Ingredients for chocolate rich product #5

| | | | | % w/w |
|---|---|---|---|---|
| | | Type and source | | final |
| Component | Ingredient | of ingredient | % w/w | product |
| Chocolate | Skim milk | 0-0.2% fat | 45.65% | 13.64% |
| Melt | Solid | milk chocolate | 50% | 15% |
| | chocolate | (29-33% cocoa | | |
| | | mass, | | |
| | | Uniliver) | | |
| | Cream | 42% fat | 4.15% | 1.24% |
| | Acidity | tetrasodium | 0.20% | 0.06% |
| | regulator | pyrophosphate | | |
| | | (E450iii) | | |
| Stabilizing | Skim milk | 0-0.2% fat | 73.88% | 51.70% |
| Composition | Cream | 42% fat | 11.12% | 7.78% |
| | Sugar | Sugat | 8.30% | 5.80% |
| | Starch | waxy maize | 3.10% | 2.20% |
| | | (E1442) | | |
| | Cocoa | D-11-S 10-12% | 2.70% | 1.90% |
| | powder | fat, ADM | | |
| | Carrageenan | E407, Tate & | 0.40% | 0.30% |
| | | Lyle | | |
| | Emulsifier | E471, Tate & | 0.40% | 0.30% |
| | | Lyle | | |
| | Vanillin | Frutarom | 0.18% | 0.01% |
| | Acidity | tetrasodium | 0.10% | 0.07% |
| | regulator | pyrophosphate | | |
| | | (E450iii) | | |

TABLE 8
Ingredients for chocolate rich product #6

| | | | | % w/w |
|---|---|---|---|---|
| | | Type and source | | final |
| Component | Ingredient | of ingredient | % w/w | product |
| Chocolate | Skim milk | 0-1.25% fat | 4.15% | 1.25% |
| Melt | powder | | | |
| | water | | 41.50% | 12.45% |
| | Solid | milk chocolate | 50% | 15% |
| | chocolate | (29-33% cocoa | | |
| | | mass, | | |
| | | Uniliver) | | |
| | Cream | 42% fat | 4.15% | 1.24% |
| | Acidity | tetrasodium | 0.20% | 0.06% |
| | regulator | pyrophosphate | | |
| | | (E450iii) | | |
| Stabilizing | Skim milk | 0-1.25% fat | 6.71% | 4.70% |
| Composition | powder | | | |
| | water | | 67.16% | 47.01% |
| | Cream | 42% fat | 11.12% | 7.78% |
| | Sugar | Sugat | 8.30% | 5.80% |
| | Starch | waxy maize | 3.10% | 2.20% |
| | | (E1442) | | |
| | Cocoa | D-11-S 10-12% | 2.70% | 1.90% |
| | powder | fat, ADM | | |
| | Carrageenan | E407, Tate & | 0.40% | 0.30% |
| | | Lyle | | |
| | Emulsifier | E471, Tate & | 0.40% | 0.30% |
| | | Lyle | | |
| | Vanillin | Frutarom | 0.18% | 0.01% |
| | Acidity | tetrasodium | 0.10% | 0.07% |
| | regulator | pyrophosphate | | |
| | | (E450iii) | | |

### Product Analysis:

### Texture Profile Analysis

Table 9 provides texture profile analysis and stability tests for product # 5 and 6.

TABLE 9
Product characterization of chocolate rich products #5 and #6

| | Chocolate | | |
|---|---|---|---|
| | rich | Comparative | Comparative |
| Parameter | product # 1 | product #5 | product #6 |
| Dry matter (%) | 38-39 | 36.1 | 37.0 |

Texture analysis

| | | | |
|---|---|---|---|
| Max force, | 0.18 | 0.16 | 0.17 |
| Gel strength, | | | |
| (kg) | | | |
| Min force, | 0.09 | 0.08 | 0.08 |
| Adhesiveness, | | | |
| (kg) | | | |
| Texture | Creamy, | Creamy, | Creamy, |
| | thick, | thick, | thick, |
| | spoonable, | spoonable, | spoonable, |
| | rich body, | rich body, | rich body, |
| | no | no | no |
| | syneresis | syneresis | syneresis |

As evident from the above Table 9, similarly to chocolate rich product #1 described earlier that exhibited preferable characteristics, chocolate rich products #5 and #6 of the present invention displayed a creamy, thick, spoonable, rich body texture with no syneresis (water separation). Further, the chocolate rich products of the present invention #5 and #6 were characterized with gel strength of 160 g and 170 g for product #5 and product #6, respectively, and adhesiveness factor of, in absolute values, 80 g for both skim-milk based products. In addition, both products exhibited microbial stability.

Thus, from Table 9, it is shown that the product of the present invention, when comprising skim milk or skim milk powder, still provides excellent product properties, such as texture and microbial stability. Therefore, any type of milk with any fat content may be used according to the present invention.

1. A method for producing a chocolate rich product comprising:
(a) in a first container, preparing a chocolate melt by mixing solid chocolate comprising cocoa butter into milk, the amount of chocolate being at least 20% (w/w) out of the total weight of the chocolate melt, said milk being at a temperature above 40° C.;
(b) in a second container, preparing a stabilizing composition by mixing at least one edible stabilizer with milk being at a temperature between about 4° C. and 55° C., said milk having a fat content that corresponds with a desired fat content of the chocolate rich product to obtain a stabilizing composition;
(c) mixing the chocolate melt with the stabilizing composition at a mixing ratio of between about 20% to 50% chocolate rich melt to about 80%-50% stabilizing composition to obtain a chocolate rich base;
(d) subjecting the chocolate rich base to a homogenization process to obtain a homogenized chocolate rich base;
(e) subjecting the homogenized chocolate rich base to a pasteurization process to obtain a pasteurized chocolate rich base; and
(f) cooling the pasteurized chocolate rich base to a final temperature of between 10° C. to 30° C. to obtain the chocolate rich product;
wherein the chocolate rich product is characterized by
at least 8% chocolate,
stability during storage at a temperature range of between 4° C. and 10° C. for a period of at least 21 days; and
dry matter in the range of 20-45%.

2. The method of claim 1, wherein the amount of chocolate being mixed with milk in the first container is in the range of 20% to 50% out of the total weight of the melt.

3. The method of claim 1, wherein said chocolate and said milk are mixed in the first container at temperature within the range of 40° C. and 80° C.

4. The method of claim 1, wherein said fat content of the solid chocolate being mixed with said milk is in the range of 29% and 33%.

5. The method of claim 1, wherein said milk is fresh milk.

6. The method of claim 1, wherein said milk is recombined milk.

7. (canceled)

8. (canceled)

9. The method of claim 1, wherein when said temperature range is between 20° C. to 55° C., said mixing is for a time period of no more than 2 hours.

10. The method of claim 1, wherein said mixing in said second container is at a temperature range of between 5° C. to 10° C.

11. The method of claim 1, comprising mixing the stabilizing composition with said chocolate melt to obtain a chocolate rich base and heating the chocolate rich base to a temperature between 40° C. and 70° C.

12. (canceled)

13. The method of claim 1, wherein said heating of the chocolate rich base is to a temperature between 50° C. and 55° C.

14. (canceled)

15. The method of claim 1, wherein said pasteurization process comprises heating the homogenized chocolate rich base to a temperature range between 100° C. to 200° C. for time duration of between 1 to 60 seconds.

16. The method of claim 1, wherein said cooling of the pasteurized chocolate rich base comprises subjecting the homogenized chocolate rich base to a first temperature of between 50° C. to 70° C. and subsequently to a second temperature of between 10° C. to 30° C.

17. The method of claim 16, wherein said pasteurized chocolate rich base is subjected to the second temperature proximal to its discharge in a storage container.

18. (canceled)

19. (canceled)

20. A chocolate rich product comprising homogenized mixture of milk, at least one edible stabilizer, and at least 8% chocolate comprising cocoa butter, the product being characterized by:
a texture profile characterized by at least one of:
stability during storage at a temperature range of between 4° C. and 10° C. for a period of at least 21 days; and
dry matter in the range of 20%-45%.

21. The chocolate rich product of claim 20, comprising between 5% to 25% of said solid chocolate.

22. (canceled)

23. (canceled)

24. The chocolate rich product of claim 20, being stable for a period of at least 25 days.

25. (canceled)

26. The chocolate rich product of claim 20, characterized by a pH of between 6.4 to 7.2.

27. (canceled)

28. The chocolate rich product of claim 20, characterized by a microbial count of less than 10 CFU/g, after storage for a period of at least 21 days.

29. (canceled)

30. The chocolate rich product of claim 20, being characterized by a homogenous texture.

31. The chocolate rich product of claim 20, being characterized by a rich chocolate mouth-feel.

32. The chocolate rich product of claim 20, obtainable by the method of claim 1.
